(19) United States
(12) Patent Application Publication
(10) Pub. No.: US 2018/0090855 A1
(43) Pub. Date: Mar. 29, 2018

(54) Connecting Element for Contacting a Shielding of a Power Cable

(71) Applicant: Tyco Electronics Raychem GmbH, Ottobrunn (DE)

(72) Inventors: Thilo Simonsohn, Munich (DE); Burghard Well, Stelle (DE)

(73) Assignee: Tyco Electronics Raychem GmbH, Ottobrunn (DE)

(21) Appl. No.: 15/818,943

(22) Filed: Nov. 21, 2017

Related U.S. Application Data
(63) Continuation of application No. PCT/EP2016/061512, filed on May 22, 2016.

(30) Foreign Application Priority Data
May 22, 2015 (EP) 15168911.4

(51) Int. Cl. H01R 4/26; H01R 13/6592

(52) U.S. Cl. CPC H01R 4/26; H01R 13/6592

(57) ABSTRACT

A connector for contacting a shielding of a cable comprises a contact electrically contacting the shielding. The contact extends circumferentially around the cable and along a longitudinal axis of the cable in a mounted state. The contact has a plurality of contact protrusions protruding toward the shielding in the mounted state. The contact protrusions are disposed in a plurality of rows spaced apart from each other by a distance in a direction extending circumferentially around the cable. Each of the rows of contact protrusions has a non-zero angle with respect to the longitudinal axis of the cable.

### CROSS-REFERENCE TO RELATED APPLICATIONS

This application is a continuation of PCT International Application No. PCT/EP2016/061512, filed on May 22, 2016, which claims priority under 35 U.S.C. § 119 to European Patent Application No. 15168911.4, filed on May 22, 2015.

### FIELD OF THE INVENTION

The present invention relates to an electrical connector and, more particularly, to an electrical connector for contacting an electrically conductive shield of a cable.

### BACKGROUND

Known cable installations for the transmission of bulk power often have single-core cables with metal sheaths or other forms of ground conductors. The metal sheath or ground conductor is usually covered with an electrically insulating oversheath (or jacket), in most cases formed of a plastic material, both to avoid uncontrolled grounding and to protect the conductor from corrosion.

A cable shield, the metallic barrier that surrounds the cable insulation, holds the outside of the cable at or near ground potential while providing a path for return current and for fault current. The shield also protects the cable from lightning strikes and from current from other fault sources. The metallic shield is also called the sheath. Medium voltage (MV, voltages above 1000 volts and below 69000 volts) power cables normally have copper or aluminum wire shields. Alternatively, power cables often also have a copper tape shield or an aluminum tape shield; these are wrapped helically or straight with an overlap section in which two layers are around the cable. This overlap area usually is parallel to the longitudinal axis of the cable. In the cable having a tape shield, the shield is not normally expected to carry unbalanced load current. A higher resistance shield permits the cable ampacity to be higher because there is less circulating current.

Particularly in MV power cable constructions, the ground-potential metallic shield is an important element because it serves to protect both the cable itself and the power system to which the cable is connected. It protects the cable itself by confining the cable's dielectric field and by providing symmetrical radial distribution of voltage stress. This limits the stress concentration at any one insulation point. It also helps dissipate heat away from the current-carrying conductor. The metallic shield can also protect the power system by conducting any fault current to the ground. Moreover, the metallic shield reduces interference with electronic equipment and also reduces the hazards of shock to anyone working with the cable. It is therefore essential that cable shields are well connected to each other at cable joints. The connection of the metallic shield to a defined grounding point is established with sufficiently high electrical and mechanical performance.

Presently, there exist several contacting systems for the metal tape shield of cables. Many of these products comprise contacts having a number of sharp upstanding protrusions which are directed outwardly when mounted on a cable. These protrusions contact or even puncture the metal film of the cable shield from the inside, being arranged between the cable shield and the inner cable insulation. The contacts having such protrusions are sometimes called “cheese graters”. In order to form such protrusions at a contact fabricated from a metal sheet, this metal sheet has to be of a certain thickness, usually around 600 μm when using copper or copper alloys as the metal. Typically, 50 or more such protrusions are provided in a contact having a size of, for example, 60 mm×30 mm.

From the article Ch. Tourcher et al.: “Connection to MV cable aluminium screen” in: 22nd International Conference on Electricity Distribution, Stockholm, 10-13 Jun. 2013, Paper 1018, it is known to interconnect the cable shields (also called “screens”) by means of contacts, so-called screen plates, that have outwardly protruding sharp pikes that grip the aluminum screen from the inside. Such a known connector 600 is shown in FIGS. 6-8.

A conventional contact 602 having a plurality of protrusions 603 is shown in FIG. 7. The protrusions 603 are arranged in thirteen rows each having five protrusions. In this conventional arrangement, each row extends exactly in parallel to the longitudinal axis of the cable. These protrusions 603 abut or puncture through the metal film of the cable shield. As shown in FIG. 6, a metal braid 604 may be soldered in a connection region 606 to the contact 602. The metal braid 604 may have a rigid end region 607 and a solder block region 605, as is known in the art. In the rigid end region 607 the metal braid 604 can be connected to the conductive shield of another cable and/or directly to ground. The solder block region 605 avoids the intrusion of water along the braid 604 from capillary forces.

FIG. 8 shows a crown shaped contact protrusion 603 that has sharp tips for puncturing the metal tape shield. In order to allow one particular product to contact cables with diameters within a certain range, the contact 602 has a width about equivalent to the circumference of the smallest cable. Consequently, the metal plate covers only a portion of the circumference when being used with cables having a larger diameter, leaving a gap 608 between peripheral edges of the contact 102.

For applications in certain markets, the metal tape and the over sheath are cut into three sectors. The cheese grater metal plate is then roughly manually adjusted to the diameter of the conductive layer by bending it and pushing it underneath the metal tape shield. For this arrangement, the number of protrusions 603 that properly puncture the metal tape is less than the total number of protrusions 603 present on the metal plate 602. Moreover, it could be shown that there is a significant variation of the number of puncturing protrusions 603 from installation to installation. In other words, there is a significant standard deviation of the number of contact points with satisfactory performance. This is due to mainly two reasons: first, after pushing the contact 602 under the metal tape, significant gaps occur between the sectors of the shield. The contact 602 is arranged with respect to these gaps randomly. Where the protrusions 603 lie below such a gap, they do not act as an electrical contact. Due to the geometry of the contact 602 as shown in FIGS. 6 and 7, where the rows of protrusions 603 extend in parallel to the longitudinal axis of the cable, a complete row of protrusions 603 might be located underneath a gap. This means that a complete row or rows of protrusions make or do not make proper contact or puncture the shield only partly, resulting in a reduced capability of transmitting current. Consequently, the standard deviation is high when comparing a larger number of installations. Second, the protrusions 603 also do not lead to the same electrical contact in those regions of the circumference where the metal tape shield is double layered.

Another known connector 900 which is mounted on a cable so that it encompasses the cable shielding from the outside, as disclosed in the published International Application WO 2014/072258 A1, is shown in FIGS. 9 and 10. The connector 900 comprises a contact 902 which is connected in a connection region 906 to an electrically conductive connecting lead 904. A roll spring 908 is provided for fixing the contact 902 over a cable shielding (not shown). As shown in FIG. 10, the inner surface of the contact 902 is provided with inwardly protruding sharp edges 903 which grip the cable shielding from outside in the mounted state. This arrangement, however, has the disadvantage of a rather high rigidity of the contact 902, so that the contact 902 tends to give way outwardly when mounted on a cable. While this is no problem for arrangements where the contact is located beneath the cable shield and where the protrusions are provided on the outer surface of the contact, the rigidity leads to a deteriorated electrical contact for arrangements in which the contact 902 encompasses the cable shield.

### SUMMARY

A connector for contacting a shielding of a cable according to the invention comprises a contact electrically contacting the shielding. The contact extends circumferentially around the cable and along a longitudinal axis of the cable in a mounted state. The contact has a plurality of contact protrusions protruding toward the shielding in the mounted state. The contact protrusions are disposed in a plurality of rows spaced apart from each other by a distance in a direction extending circumferentially around the cable. Each of the rows of contact protrusions has a non-zero angle with respect to the longitudinal axis of the cable.

### BRIEF DESCRIPTION OF THE DRAWINGS

The invention will now be described by way of example with reference to the accompanying figures, of which:

FIG. 1 is a plan view of a contact according to an embodiment of the invention;

FIG. 2 is a plan view of a contact according to another embodiment of the invention;

FIG. 3 is a plan view of a contact according to another embodiment of the invention;

FIG. 4 is a plan view of a contact according to another embodiment of the invention;

FIG. 5 is a perspective view of a connector according to the invention;

FIG. 6 is a perspective view of a conventional connector;

FIG. 7 is a plan view of a contact of the conventional connector of FIG. 6;

FIG. 8 is a sectional view of a protrusion of the contact of FIG. 7.

FIG. 9 is a perspective view of another conventional connector; and

FIG. 10 is an end view of the conventional connector of FIG. 9.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

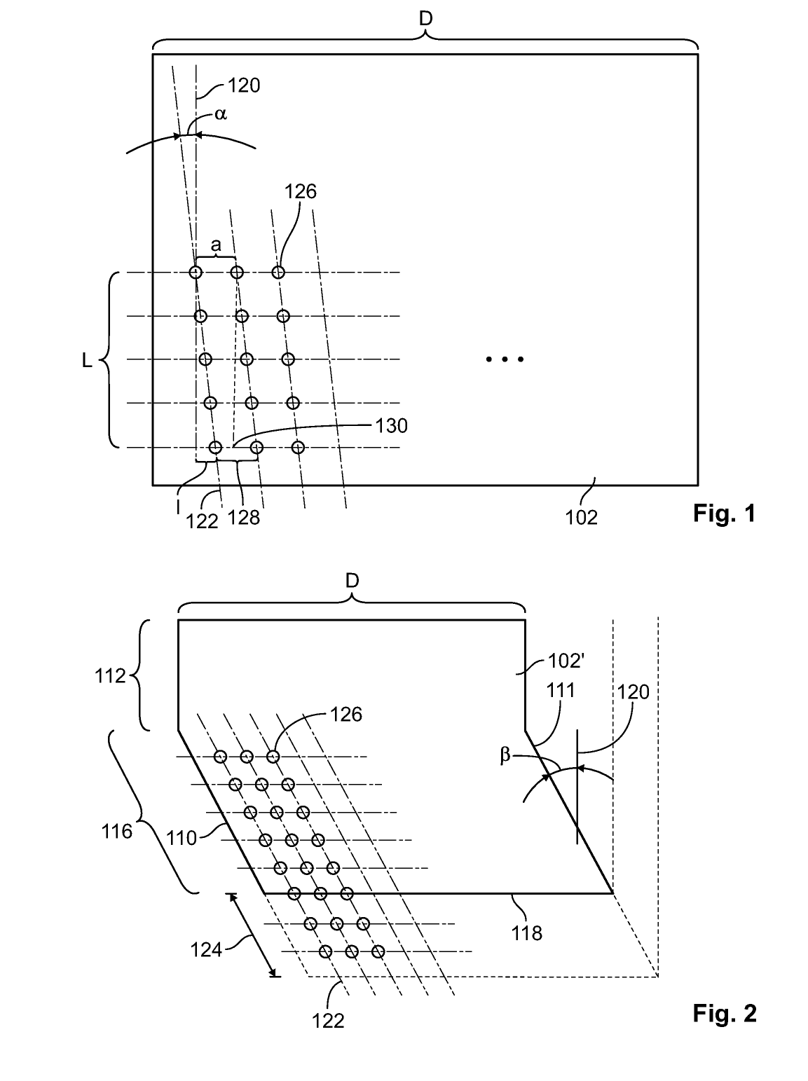

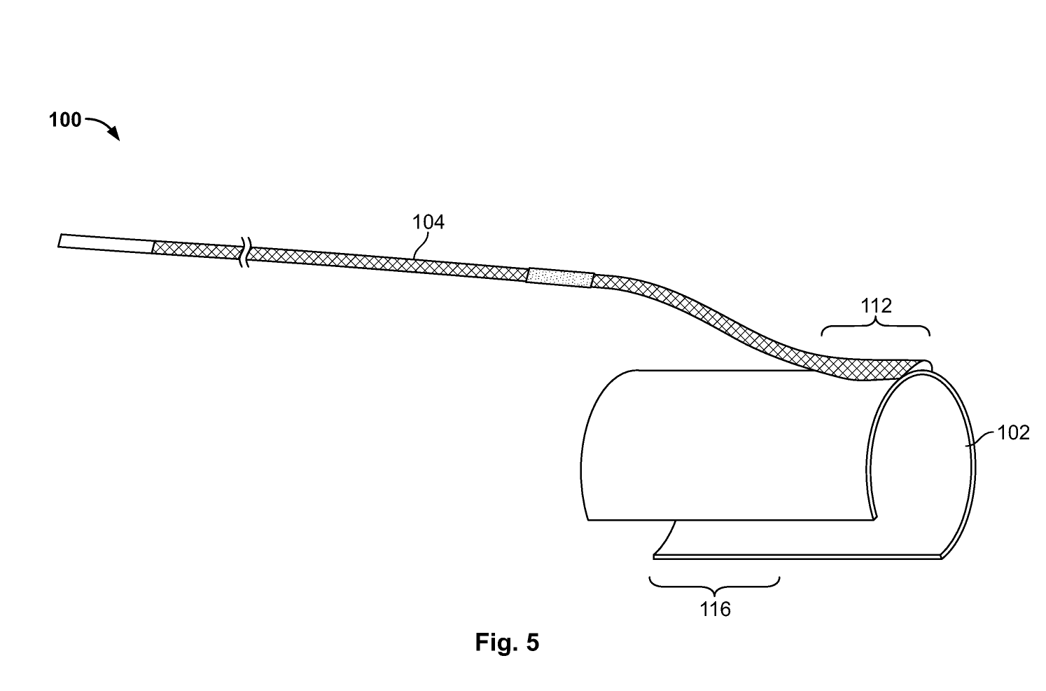

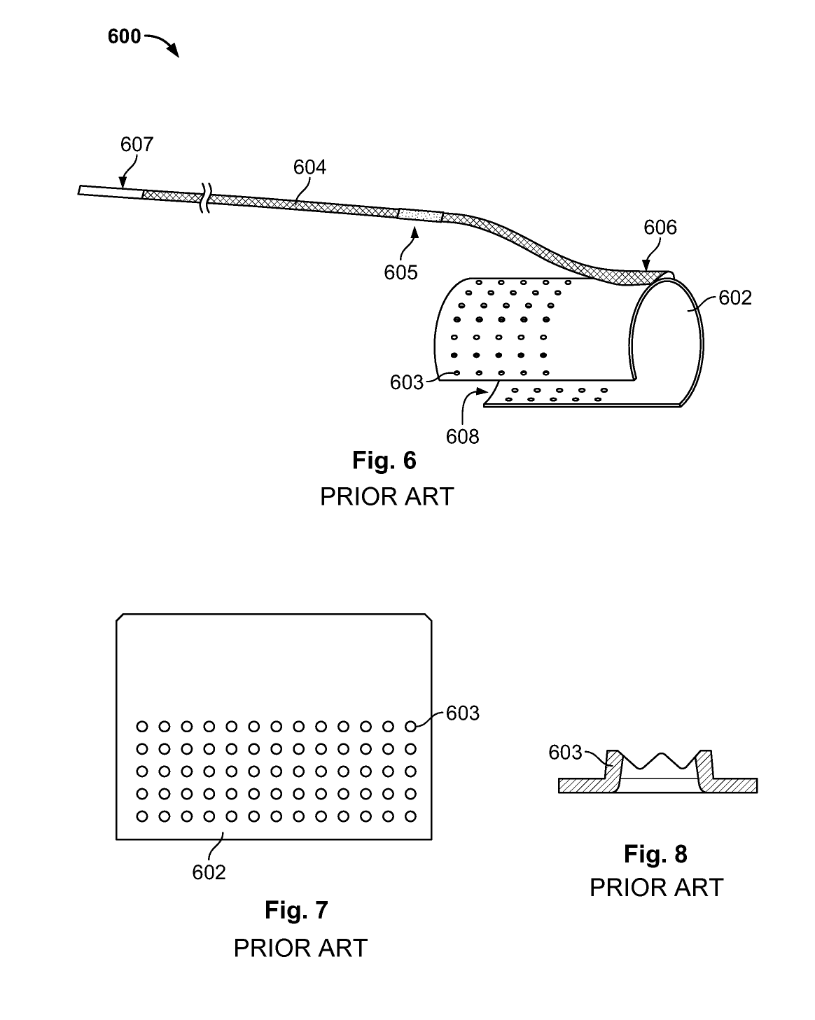

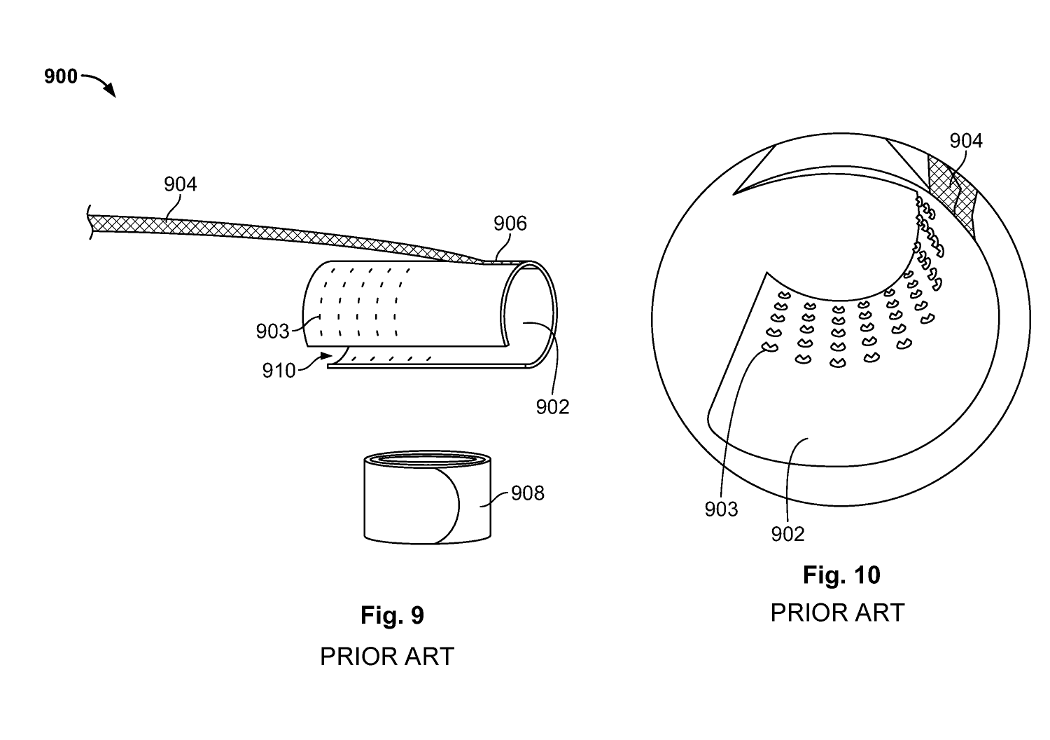

A contact 102 of a connector 100 according to an embodiment is shown in FIGS. 1 and 5. The contact 102 has a plurality of protrusions 126 arranged in rows 122. Each of the rows 122 has an angle α with respect to a longitudinal axis 120 of the cable.

In an embodiment, the protrusions 126 each have a same shape as the shape of the protrusion 603 shown in FIG. 8. In other embodiments, the shape of the protrusions 126 may vary. In a mounted state on the cable, the protrusions 126 protrude inwardly or outwardly toward a shielding layer of the cable. The protrusions 126 grip the shielding layer and puncture the surface of the shielding layer in order to overcome contact deterioration due to oxide or contamination layers. The protrusions 126 are formed by stamped and bent cut-outs which thereby form sharp teeth that grip the cable shielding layer in a mounted state. In another embodiment, the protrusions 126 are each formed by an elongated contact blade disposed on a surface of the contact 102.

The angle α is chosen so that the deviation I of the contact protrusion 126 at one end of the row 122 with respect to the contact protrusion 126 at the other end of the same row 122, as shown in FIG. 1, is smaller than a distance a, 128 between two adjacent rows 122. Using the functional correlation that tan α=1/L, this requirement can be expressed mathematically as follows:

I=L tan α<a (1)
[symbol] tan α<α/L
[symbol] α<arctan α/L

The tangent of α is smaller than a ratio of the distance 128 between two rows and the length L of the contact region. Consequently, when considering a position of the top most contact protrusion 126 along the longitudinal axis 120, the lowest protrusion 126 of the neighboring row 122 still is spaced apart from a projection point 130 of the top most protrusion 126 along the longitudinal axis 120 and at a position parallel to the lowest protrusion 126. Complete rows 122 of contact protrusions 126 are thus not formed in parallel to the longitudinal axis of the cable and the variation in the number of well-contacting contact protrusions 126 in the mounted state is reduced; complete rows 122 of protrusions 126 are no longer located adjacent to a gap in the shield to be contacted. In an embodiment, the angle α is between 1° and 45°, and in another embodiment, is between 3° and 15°.

The above equation (1) may also be written as

1=L tan α<n·a (2)

with n being the number of protrusions 126 in a row 122. In other words, the rows 122 under the angle α would overlap seen from the axis of the cable without accounting for n protrusions. There are no protrusions 126 that are positioned with respect to any other protrusions 126 on a common axis parallel to the longitudinal axis of the cable.

In other embodiments, the contact protrusions 126 may also be arranged in a way that they only partially form rows 122. Further, instead of straight lines, the rows 122 may be formed in curved lines or zigzag lines in other embodiments.

The connector 100 shown in FIG. 5 having the contact 102 can be used with a large range of cable diameters without modification. An overall width D of the contact 102 as shown in FIG. 1 is less than π·d, wherein d denotes the outer diameter of the cable where an electrical contact is to be established, such that the contact 102 does not overlap itself. For example, for a cable diameter of d=29 mm, the maximum admissible width is therefore D=π·d=91 mm.

A contact 102′ according to another embodiment of the invention is shown in FIG. 2. The contact 102′ has a connecting region 112 and a contact region 116. The contact region 116 which carries the contact protrusions 126 has a parallelogram shaped outline. Opposing edges 110, 111 (which in a mounted state extend along the cable) form an angle β with a longitudinal axis 120 of the cable and correspondingly enclose an angle of 90°-β with a circumferential edge 118. In an embodiment, the angle β is between 1° and 45°, and in the embodiment shown in FIG. 2, is about 30°.

By changing the contact region 116 to have a parallelogram shaped outline as shown in FIG. 2, the smallest cable diameter having a circumference corresponding to D may still be covered without overlapping. However, when mounting the contact 102′ shown in FIG. 2 on a cable with a larger diameter, the opposing edges 110, 111 form a gap between each other which is not exactly parallel to the cable longitudinal axis 120 but winds around the cable circumference as a part of a spiral. Consequently, in total a larger circumference than D can be connected with the contact protrusions 126.

The contact protrusions 126, as shown in FIG. 2, are arranged in rows 122 which also have the angle β with respect to the longitudinal axis 120 of the cable. By arranging the protrusions 126 in rows 122 that are not parallel to the longitudinal axis 120, complete rows 122 are not located adjacent to a gap in the metal shield and therefore are not lost for giving proper electrical contact. The variation in well-connected protrusions 126 can be reduced over a larger number of installations, improving performance of the contact 102′.

In an embodiment, the parallelogram shaped outline of the contact region 116 may have an increased length in a direction along the cable by an additional extended length 124. For example, the contact region 116 may have a length of 50 mm instead of 30 mm.

In various embodiments, the contact protrusions 126 may be arranged around the circumference with varying numbers and distances or patterns. Beside the straight parallelogram shown in FIG. 2, of course, also other shapes of the edges 110, 111, such as curved ones, are possible. The edges 110, 111 should match with each other without leaving significant gaps when being mounted around the smallest rated cable. The edges 110, 111 may also be stepped or have any other suitable shape.

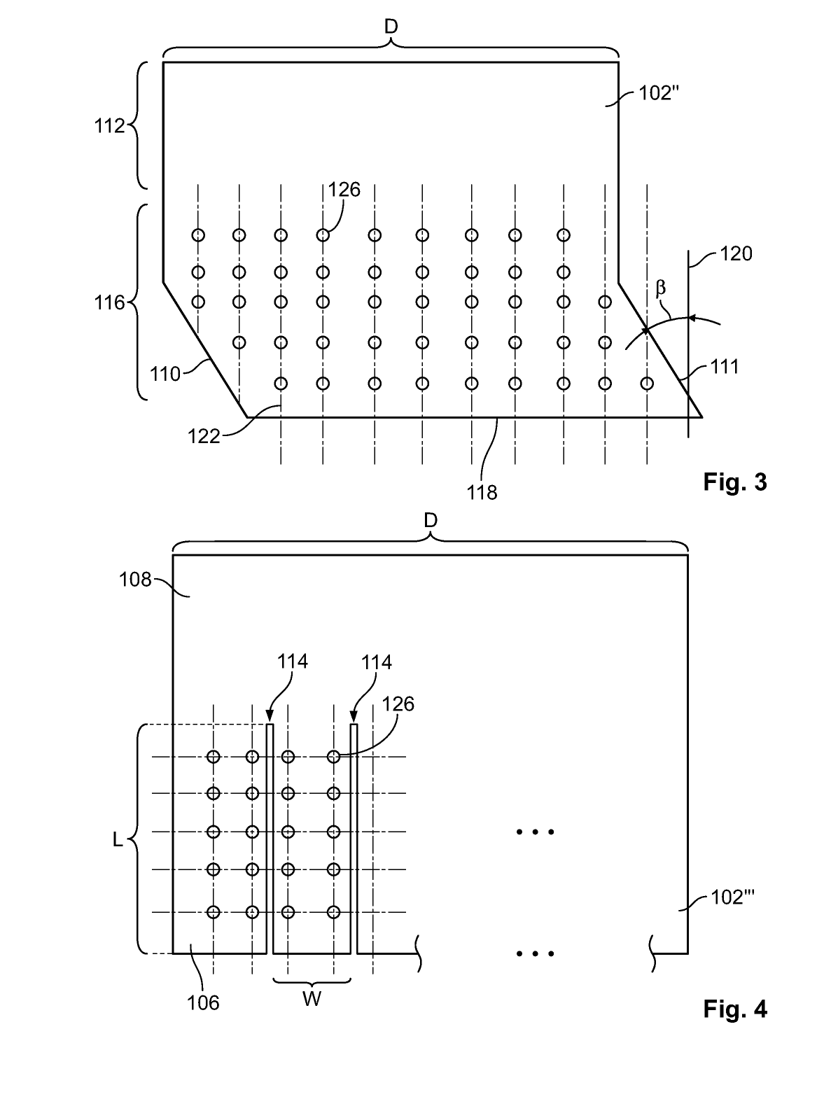

A contact 102″ according to another embodiment is shown in FIG. 3. The contact region 116 has a partly rectangular and a partly parallelogram shaped form. In this embodiment, the contact protrusions 126 are arranged in rows 122 essentially in parallel to the longitudinal axis 120 of the cable, but a larger portion of the circumference of the cable can be contacted in instances in which the contact 102″ is installed on cables with a larger diameter than the smallest rated diameter.

A contact 102′″ according to another embodiment of the invention is shown in FIG. 4. The contact 102′″ is divided into a plurality of contact segments 106 that are each interconnected in a joint region 108. The contact 102′″ is formed from a cut and punched metal sheet.

The contact segments 106 are fabricated as freestanding elongated arms by providing a plurality of narrow and elongated cut-outs 114. In a mounted state, the contact 102′″ is bent to have a hollow cylindrical shape or a C-shape which encompasses the cable. Each of the contact segments 106 has a length L which extends along a longitudinal axis of the cable and a width W extending along the circumference of the cable. In the shown embodiment, the shape of the contact segments 106 is rectangular, but in other embodiments may have any arbitrary shape. Within the same contact 102′″, the contact segments 106 are either identical or contact segments 106 with different shapes can be combined. In an embodiment, the contact segments 106 are formed from an electrically conductive material, such as copper or a copper alloy, and the joint region 108 is formed from the same material or a different material. The contact segments 106 may be integrally formed with the joint region 108 or formed separately from and attached to the joint region 108.

By providing contact segments 106 which are interconnected only via the joint region 108, the contact 102′″ is much more flexible than a solid metal sheet. The same alloy, sheet thickness, and size can be used, thus ensuring a sufficient ampacity and allowing for the fabrication of protrusions 126 for contacting the cable shielding. In an exemplary embodiment, copper alloy sheets with a thickness of about 500 μm are used.

Each contact segment 106, as shown in FIG. 4, has a plurality of contact protrusions 126. In an embodiment, each contact protrusion 126 is spaced apart from its neighboring contact protrusion 126 by 5 mm. The contact segments 106 at the peripheral region of the contact 102′″ are slightly broader than the contact segments 106 in the middle. In other embodiments, identical contact segments 106 may be provided along the complete width D of the contact 102′″. The contact 102′″ is divided in at least two contact segments 106, and in some embodiments, into more than five contact segments 106.

The contact 102′″ has a connecting region 112 arranged in the joint region 108 which is adapted to be connected to a connecting lead 104 shown in FIG. 5. In the connecting region 112, a connecting lead 104 comprising a metal braiding or the like can be attached by a press fit with roll springs, ties, heat shrink sleeves, worm drive clips or the like. The connecting lead 104 may also be attached by welding, soldering, or riveting when fabricating the connector 100.

There exist several possibilities to fabricate the contact 102 shown in FIG. 4. Firstly, a solid metal sheet may be provided with the cut-outs 114 by appropriate processing techniques, such as punching, water jet cutting, or laser cutting. The thickness of the joint region 108 may also differ from the thickness of the contact segments 106. This may be achieved by deforming the metal blank by pressing with high forces using an appropriate blade tool. Bonding individual stripes forming the contact segments 106 onto plastic film or a thinner metal blank is another option.

The orientation of the contact segments 106 is essentially parallel to the longitudinal axis of the cable when being mounted on the cable having the smallest diameter. In other embodiments, the orientation may be not parallel to the axis of the cable, and may have an angle β as shown in FIG. 2.

A connector 100 based on any of the contacts 102, 102′, 102″, 102′″ of FIGS. 1-4 is shown in FIG. 5 in the pre-assembled state; before it is assembled around the cable. For connecting the connector 100 to a grounding point or to another cable shielding, the connector 100 further comprises an electrically conductive connecting lead 104. In the embodiment shown in FIG. 5, the connecting lead 104 is a metal braiding. Such a metal braiding may, for instance, be a tubular sleeve made from stainless steel or from tinned copper. All other suitable forms of the connecting lead 104 may also be combined with the contact 102 according to the present invention, such as cables or flat band conductors. Moreover, the connector 100 may also comprise only the contact 102, 102′, 102″, 102′″ without any additional connection lead.

The connection between the contact 102 and the connection lead 104 can be established while assembling the connector 100 at the cable by clamping devices such as a roll spring, a cable tie, or a heat shrink or cold shrink recoverable sleeve which press the contact 102 onto the shielding of the cable. In other embodiments, the connector 100 can be pre-assembled in a factory; the connection lead 104 connected to the connecting region 112 using well-established contacting techniques, such as welding, soldering, crimping, or riveting. Alternatively, the connection lead 104 can also be connected in the contact region 116. In this case, the contact 102 dispenses with a separate connecting zone 112.

The connecting lead 104, as shown in FIG. 5, leads away from the connecting region 112 in a straight manner and in line with the longitudinal axis of the cable. Hence, no sharp bending of the lead 104 is necessary which could be a problem for any sleeves covering the connector 100.

In order to ensure a sufficient mechanical stability, the metal braiding 104 can be rolled flat and/or compacted before being connected to the contact 102. Moreover, in an embodiment, a welding of the metal braiding 104 onto the contact 102 is only performed after bending the initially flat contact 102 at least partially into its final cylindrical or C-shaped form.

What is claimed is:

1. A connector for contacting a shielding of a cable, comprising:
a contact electrically contacting the shielding and extending circumferentially around the cable and along a longitudinal axis of the cable in a mounted state, the contact having a plurality of contact protrusions protruding toward the shielding in the mounted state, the contact protrusions disposed in a plurality of rows spaced apart from each other by a distance in a direction extending circumferentially around the cable and each forming a non-zero angle with respect to the longitudinal axis of the cable.

2. The connector of claim 1, wherein the angle is less than an arctangent of a ratio of the distance between two rows and a length of a row along the longitudinal axis.

3. The connector of claim 1, wherein the angle is between 1° and 45°.

4. The connector of claim 3, wherein the angle is between 3° and 15°.

5. A connector for contacting a shielding of a cable, comprising:
a contact electrically contacting the shielding and having a contact region with a plurality of contact protrusions protruding toward the shielding in a mounted state, the contact region is an electrically conductive sheet having a parallelogram-shaped outline.

6. The connector of claim 5, wherein the contact protrusions are disposed in a plurality of rows extending along an edge of the contact region.

7. The connector of claim 6, wherein each of the rows has a non-zero angle with respect to a longitudinal axis of the cable in the mounted state.

8. The connector of claim 5, wherein each contact protrusion protrudes inwardly toward the shielding.

9. The connector of claim 5, wherein each contact protrusion protrudes outwardly toward the shielding.

10. The connector of claim 5, wherein each contact protrusion is formed by stamped and bent cut-outs.

11. The connector of claim 5, wherein each contact protrusion is formed by an elongated contact blade disposed on a surface of the contact.

12. The connector of claim 5, further comprising an electrically conductive connecting lead connected to the contact and adapted to connect the contact to a grounding point or a shielding of another cable.

13. The connector of claim 12, wherein the connecting lead is a metal braiding.

14. The connector of claim 5, further comprising a clamping element pressing the contact onto the shielding.

15. The connector of claim 14, wherein the clamping element is at least one of a worm drive clip, a roll spring, a cable tie, and a recoverable sleeve.

16. A contact for contacting a shielding of a cable, comprising:
a plurality of electrically conductive contact segments each having a plurality of contact protrusions protruding toward the shielding in the mounted state and disposed in a plurality of rows spaced apart from each other by a distance in a direction extending circumferentially around the cable; and
a joint region interconnecting the contact segments.

17. The contact of claim 16, wherein each of the contact segments is an elongated arm extending from the joint region and separated from the other contact segments.

18. The contact of claim 16, wherein each row of contact protrusions extends parallel to a longitudinal direction of the cable.
